(19) United States
(12) Patent Application Publication
(10) Pub. No.: US 2025/0189768 A1
(43) Pub. Date: Jun. 12, 2025

(54) OPTICAL IMAGING SYSTEM

(71) Applicant: Samsung Electro-Mechanics Co., Ltd., Suwon-si (KR)

(72) Inventors: Seong Il CHO, Suwon-si (KR); Do Hyeong JANG, Suwon-si (KR); Tae Yeon LIM, Suwon-si (KR); Hag Chul KIM, Suwon-si (KR)

(73) Assignee: Samsung Electro-Mechanics Co., Ltd., Suwon-si (KR)

(21) Appl. No.: 18/921,339

(22) Filed: Oct. 21, 2024

(30) Foreign Application Priority Data
Dec. 7, 2023 (KR) 10-2023-0176971
May 16, 2024 (KR) 10-2024-0064110

(51) Int. Cl. G02B 13/00; G02B 9/60

(52) U.S. Cl. CPC G02B 13/0065; G02B 9/60; G02B 13/0045

(57) ABSTRACT

An optical imaging system includes a first lens group, including one or more lenses, having positive refractive power; a second lens group including a plurality of lenses; and a reflective member, disposed between the first lens group and the second lens group, including an incident surface, a reflective surface, and an emitting surface. The optical imaging system satisfies 1.3<SD1/SDP<1.7, where SD1 is an effective diameter of an object-side surface of a first lens disposed closest to an object side among the one or more lenses of the first lens group, and SDP is a minor-axis length of the incident surface of the reflective member.

### CROSS-REFERENCE TO RELATED APPLICATION(S)

This application claims the benefit under 35 USC 119(a) of Korean Patent Application No. 10-2024-0064110, filed on May 16, 2024, and Korean Patent Application No. 10-2023-0176971, filed on Dec. 7, 2023, in the Korean Intellectual Property Office, the entire disclosures of which are incorporated herein by reference for all purposes.

### BACKGROUND

### 1. Field

The present disclosure relates to an optical imaging system.

### 2. Description of the Background

Portable terminals may include a camera with an optical imaging system that has a plurality of lenses to enable video calls and image capturing.

A portable terminal may be designed to have a reduced size, which may include the camera in the portable terminal; thus, developing an optical imaging system with a slim size but high resolution may be desirable.

To implement a camera for a portable terminal having telephoto properties, an optical axis of a plurality of lenses may be disposed to be parallel to a length direction or a width direction of a portable terminal, and a reflective member may be disposed on a front side of the plurality of lenses such that a total track length of the optical imaging system may not affect a thickness of the portable terminal.

However, in this structure, as the diameters of the plurality of lenses increase, the thickness of the portable terminal may also increase.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, including one or more lenses, having positive refractive power; a second lens group including a plurality of lenses; and a reflective member, disposed between the first lens group and the second lens group, including an incident surface, a reflective surface, and an emitting surface. The optical imaging system satisfies 1.3<SD1/SDP<1.7, where SD1 is an effective diameter of an object-side surface of a first lens disposed closest to an object side among the one or more lenses of the first lens group, and SDP is a minor-axis length of the incident surface of the reflective member.

The reflective member and the first lens group may be configured to rotate together with respect to two axes perpendicular to each other.

The two axes may be perpendicular to an optical axis of the second lens group.

The optical imaging system may satisfy 2.1<f/SDP<2.4, where f is a total focal length of the optical imaging system.

The optical imaging system may satisfy 0.6<IMG HT/BFL<0.8, where IMG HT is half a diagonal length of an imaging plane, and BFL is a distance from an image-side surface of a lens disposed closest to the imaging plane, among the plurality of lenses of the second lens group, to the imaging plane.

The optical imaging system may satisfy 0.2<|R10/f|<0.5, where R10 is a radius of curvature of an image-side surface of a lens disposed closest to an imaging plane among the plurality of lenses of the second lens group, and f is a total focal length of the optical imaging system.

The optical imaging system may satisfy 1.0<Lf/IMG HT<1.5, where Lf is a distance from the object-side surface of the first lens to the reflective surface of the reflective member, and IMG HT is half a diagonal length of an imaging plane.

The optical imaging system may satisfy 4.0<fG1/f<8.0, where fG1 is a focal length of the first lens group, and f is a total focal length of the optical imaging system.

The optical imaging system may satisfy |(R1-R2)/(R1+R2)|<0.4, where R1 is a radius of curvature of the object-side surface of the first lens, and R2 is a radius of curvature of an image-side surface of the first lens.

The optical imaging system may satisfy 1.2<SD1/BFL<1.9, where BFL is a distance from an image-side surface of a lens disposed closest to an imaging plane, among the plurality of lenses of the second lens group, to the imaging plane.

The optical imaging system may satisfy 0.9<CT5/ET5<1.8, where CT5 is a thickness on an optical axis of a lens disposed closest to an imaging plane among the plurality of lenses of the second lens group, ET5 is a thickness on an end of an effective diameter of the lens disposed closest to the imaging plane among the plurality of lenses of the second lens group.

An Abbe number of the first lens is greater than an Abbe number of the reflective member.

The second lens group may have positive refractive power, and a focal length of the second lens group may be smaller than a focal length of the first lens group.

The optical imaging system may satisfy 4<fG1/fG2<8, where fG1 is a focal length of the first lens group, and fG2 is a focal length of the second lens group.

A lens disposed closest to the reflective member, among the plurality of lenses of the second lens group, may have positive refractive power.

The first lens group may include the first lens, and the object-side surface of the first lens may be convex and an image-side surface of the first lens may be concave.

Other features and aspects will be apparent from the following detailed description, the drawings, and the claims.

### BRIEF DESCRIPTION OF DRAWINGS

FIG. 1 is a configuration diagram illustrating an optical imaging system according to a first embodiment of the present disclosure.

FIG. 2 is a graph indicating the aberration properties of the optical imaging system illustrated in FIG. 1.

FIG. 3 is a configuration diagram illustrating an optical imaging system according to a second embodiment of the present disclosure.

FIG. 4 is a graph indicating the aberration properties of the optical imaging system illustrated in FIG. 3.

FIG. 5 is a configuration diagram illustrating an optical imaging system according to a third embodiment of the present disclosure.

FIG. 6 is a graph indicating the aberration properties of the optical imaging system illustrated in FIG. 5.

FIG. 7 is a configuration diagram illustrating an optical imaging system according to a fourth embodiment of the present disclosure.

FIG. 8 is a graph indicating the aberration properties of the optical imaging system illustrated in FIG. 7.

FIG. 9 is a configuration diagram illustrating an optical imaging system according to a fifth embodiment of the present disclosure.

FIG. 10 is a graph indicating the aberration properties of the optical imaging system illustrated in FIG. 9.

FIG. 11 is a configuration diagram illustrating an optical imaging system according to a sixth embodiment of the present disclosure.

FIG. 12 is a graph indicating the aberration properties of the optical imaging system illustrated in FIG. 11.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An effective aperture radius of a lens surface is a radius of a portion of the lens surface through which light actually passes, and is not necessarily a radius of an outer edge of the lens surface. An object-side surface of a lens and an image-side surface of the lens may have different effective aperture radiuses.

Stated another way, an effective aperture radius of a lens surface is a distance in a direction perpendicular to an optical axis of the lens surface between the optical axis of the lens surface and a marginal ray of light passing through the lens surface.

According to an embodiment, an optical imaging system may include a plurality of lenses arranged along an optical axis. The plurality of lenses may be spaced apart from each other by a predetermined distance along the optical axis. As an example, an optical imaging system may include five lenses.

In each lens, an object-side surface may refer to a surface close to an object side, and an image-side surface may refer to a surface close to an image side. In embodiments, a unit of values of radius of curvature, thickness, distance, and focal length may be mm, and a unit of a field of view (FOV) may be degree.

In the description related to the shape of a lens of the embodiments, a convex surface may indicate that a paraxial region (a narrow region in the vicinity of an optical axis) portion of a surface may be convex, and a concave surface may indicate that a paraxial region portion of the surface may be concave.

A paraxial region may refer to a relatively narrow area near the optical axis.

An imaging plane may refer to a virtual plane on which a focus is formed by an optical imaging system. Alternatively, the imaging plane may refer to one surface of the image sensor in which light is received.

An optical imaging system according to an embodiment may include a plurality of lens groups. As an example, an optical imaging system may include a first lens group and a second lens group.

The first lens group may include one or more lenses, and the second lens group may include a plurality of lenses.

In an embodiment, the first lens group may include a first lens, and the second lens group may include a second lens, a third lens, a fourth lens, and a fifth lens. The first to fifth lenses may be disposed in order from an object side.

A plurality of lenses included in the optical imaging system may be spaced apart from each other.

Also, the optical imaging system may further include a reflective member having a reflective surface configured to change an optical path. The reflective surface of the reflective member may be configured to change the optical path by 90°.

The reflective member may be disposed between the first lens group and the second lens group. In an embodiment, the reflective member may be disposed between the first lens and the second lens.

The reflective member may be a mirror or a prism having a reflective surface.

When the reflective member is implemented as a prism, the reflective member may have a form in which a rectangular parallelepiped or a cube is bisected diagonally. The prism may include an incident surface to which light is incident, a reflective surface configured to reflect light passing through the incident surface, and an emitting surface from which light reflected from the reflective surface is emitted.

The reflective member may include three surfaces, each having a quadrangular shape, and two surfaces, each having a triangular shape. For example, each of the incident surfaces, the reflective surface, and the emitting surface of the reflective member may have a quadrangular shape, and both surfaces of the reflective member may have an almost triangular shape.

The optical axis of the first lens group and the optical axis of the second lens group may be perpendicular to each other. In an embodiment, the optical axis direction of the first lens group may be substantially parallel to a thickness direction of a portable terminal on which the optical imaging system is mounted, and the optical axis direction of the second lens group may be substantially parallel to a length direction or a width direction of the portable terminal.

By changing the direction of light through the reflective member, an optical path may be elongated in a relatively narrow space.

For example, light passing through the first lens may pass through the incident surface of the reflective member, the optical path of light may be changed by 90° on the reflective surface, light may pass through the emitting surface of the reflective member and may be incident to the second lens.

Accordingly, the optical imaging system may have a relatively long focal length while having a reduced size.

The optical imaging system, according to an embodiment, may have characteristics of a telephoto lens with a relatively narrow field of view and a relatively long focal length.

To reduce the sizes of the portable terminal and the optical imaging system, it may be desirable to reduce the diameters of lenses positioned between the reflective member and the image sensor. However, as the diameter of the lenses reduces, Fno (the F-number of the optical imaging system) increases, images may be darkened.

Accordingly, the optical imaging system, according to an embodiment, may reduce Fno by disposing the first lens group having positive refractive power on a front side of the reflective member. Also, an effective diameter of the lens included in the first lens group may be larger than a minor-axis length of the incident surface of the reflective member. For example, an effective diameter of an object-side surface and an effective diameter of an image-side surface of a lens included in the first lens group may be larger than a minor-axis length of the incident surface of the reflective member.

The lens included in the first lens group may have an almost circular shape when viewed in the optical axis direction of the first lens group.

The reflective member may be disposed on a front side of the second lens group. The reflective member may rotate with respect to two axes for image stabilization during photographing.

In other words, when shaking occurs due to factors such as hand-shake of a user when obtaining an image or video, image stabilization may be performed by rotating the reflective member in response to the shaking.

In an embodiment, the reflective member may rotate using the optical axis of the first lens group (or an axis parallel to the axis) as a rotation axis (Yaw rotation axis), and may rotate using an axis perpendicular to both the optical axis of the first lens group and the optical axis of the second lens group (or an axis parallel to the axis) as a rotation axis (pitch rotation axis).

Since the first lens group having positive refractive power is disposed on a front side of the reflective member, light incident to the reflective member may be converged, and accordingly, a diameter of the second lens group may be configured to be small. Accordingly, a height of the optical imaging system may be reduced and also the Fno of the optical imaging system may be reduced.

Also, the first lens group may rotate together with the reflective member.

The optical imaging system may further include an image sensor for converting an image of an incident subject into an electrical signal.

Also, the optical imaging system may further include an infrared cut-off filter (hereinafter, referred to as “filter”) to block infrared rays. The filter may be disposed between the second lens group and the imaging plane.

Also, the optical imaging system may further include an aperture for controlling the amount of light.

An effective radius of the first lens may be larger than an effective radius of other lenses. In other words, among the first to fifth lenses, the effective radius of the first lens may be the largest.

The first lens may have a shape different from the shapes of other lenses. For example, when viewed in the optical axis direction, the first lens may have a substantially circular shape, and one or more lenses among the second lens to the fifth lens may have a non-circular shape. For example, the first lens may have a circular planar shape, and the second lens to the fifth lens may have a non-circular planar shape.

In a plane perpendicular to the optical axis, a non-circular lens may have a longer length in the first axial direction perpendicular to the optical axis than a length in the second axial direction perpendicular to both the optical axis and the first axial direction. As for a non-circular lens, a ratio of the length in the second axial direction to the length in the first axial direction may be greater than 0.5 and less than 1.

For example, the non-circular lens may have a shape in which a portion of a circle is cut out when viewed in the optical axis direction.

Here, the first axial direction may be the direction in which a long side of the image sensor extends, and the second axial direction may be the direction in which a short side of the image sensor extends.

The non-circular lens may have a length in the first axial direction longer than the length in the second axial direction, such that the non-circular lens may have a major axis effective radius and a minor axis effective radius.

In the tables below, “effective radius” may indicate a major axis effective radius.

In an embodiment, the first to the fifth lenses may be formed of a plastic material.

One or more lenses among the first lens to the fifth lens may have at least one aspherical surface.

Here, the aspherical surface of each lens may be represented as equation 1.

$$Z = \frac{c {Y}^{2}}{1 + \sqrt{1 - ( 1 + K ) {c}^{2} {Y}^{2}}} + A {Y}^{4} + B {Y}^{6} + C {Y}^{8} + D {Y}^{10} + E {Y}^{12} + F {Y}^{14} + G {Y}^{16} + H {Y}^{18} + J {Y}^{20} + L {Y}^{22} + M {Y}^{24} + N {Y}^{26} + {OY}^{28} + P {Y}^{30}$$

In equation 1, c may be the curvature of the lens (reciprocal of the radius of curvature), K may be the conic constant, and Y may be the distance from an arbitrary point on the aspherical surface of the lens to the optical axis. Also, constants A-H, J, L-P may be aspherical surface coefficients. Z(SAG) may be the distance in the optical axis direction between an arbitrary point on the aspherical surface of the lens and an apex of the aspherical surface.

The optical imaging system, according to an embodiment, may satisfy one or more conditional expressions below.

In an embodiment, the optical imaging system may satisfy condition 1.3<SD1/SDP<1.7. Here, SD1 may be the effective diameter of an object-side surface of the lens disposed closest to an object side (e.g., the first lens) among one or more lenses of the first lens group, and SDP may be a minor-axis length of the incident surface of the reflective member.

Accordingly, image brightness may improve, and the optical imaging system may be reduced in size.

In an embodiment, the optical imaging system may satisfy condition 2.1<f/SDP<2.4. Here, f may be the total focal length of the optical imaging system. Since the first lens is disposed on a front side of the reflective member, the size of the reflective member may be reduced such that the optical imaging system may have a reduced size.

In an embodiment, the optical imaging system may satisfy condition 0.6<IMG HT/BFL<0.8. Here, IMG HT may be half the diagonal length of the imaging plane of the image sensor, and BFL may be the distance from an image-side surface of the last lens (e.g., fifth lens) of the second lens group to the imaging plane. Accordingly, the optical imaging system may have sufficient telephoto performance.

In an embodiment, the optical imaging system may satisfy condition 0.2<|R10/f|<0.5. Here, R10 may be the radius of curvature of an image-side surface of the last lens (e.g., fifth lens) of the second lens group. Accordingly, the curvature of the field of view may be effectively calibrated.

In an embodiment, the optical imaging system may satisfy condition 1.0<Lf/IMG HT<1.5. Here, Lf may be the distance from an object-side surface of the first lens (e.g., first lens) of the first lens group to the reflective surface of the reflective member. Accordingly, the optical imaging system may have a reduced size.

In an embodiment, the optical imaging system may satisfy condition 4.0<fG1/f<8.0. Here, fG1 may be the focal length of the first lens group. Accordingly, by optimizing the focal length of the first lens group, the diameters of the lenses included in the second lens group may be reduced.

In an embodiment, the optical imaging system may satisfy condition |(R1−R2)/(R1+R2)|<0.4. Here, R1 may be the radius of curvature of an object-side surface of the first lens (e.g., first lens) of the first lens group, and R2 may be the radius of curvature of an image-side surface of the first lens (e.g., first lens) of the first lens group. Accordingly, spherical aberration occurring in the first lens group may be reduced.

In an embodiment, the optical imaging system may satisfy condition 1.2<SD1/BFL<1.9, which may improve image brightness and allow for adequate telephoto performance and a reduced size for the optical imaging system.

In an embodiment, the optical imaging system may satisfy condition 0.9<CT5/ET5<1.8. Here, CT5 may be the thickness on the optical axis of the last lens (e.g., fifth lens) of the second lens group, and ET5 may be the thickness on an end of the effective diameter of the last lens (e.g., fifth lens) of the second lens group. Accordingly, the curvature of the field of view may be effectively calibrated.

In an embodiment, an Abbe number of the first lens may be greater than an Abbe number of the reflective member. Accordingly, chromatic aberration may be effectively calibrated.

In an embodiment, the optical imaging system may satisfy condition 0.25<D1P/DR<0.5. Here, D1P may be the distance on the optical axis between the first lens group and the reflective member (incident surface of the reflective member). For example, D1P may be the distance on the optical axis from an image-side surface of the first lens to the incident surface of the reflective member. DR may be the distance on the optical axis from the incident surface of a reflective member to the reflective surface of the reflective member. Accordingly, the optical imaging system may have a reduced size.

In an embodiment, the optical imaging system may satisfy condition 1<fG2/f<1.5. Here, fG2 may be the focal length of the second lens group. Accordingly, the optical imaging system may have a reduced size and an improved resolution.

In an embodiment, the optical imaging system may satisfy condition 4<fG1/fG2<8. Accordingly, by appropriately distributing the refractive power of each lens group, the optical imaging system may have a reduced size and an improved resolution.

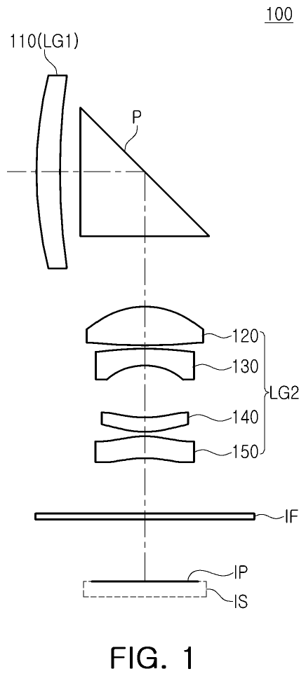

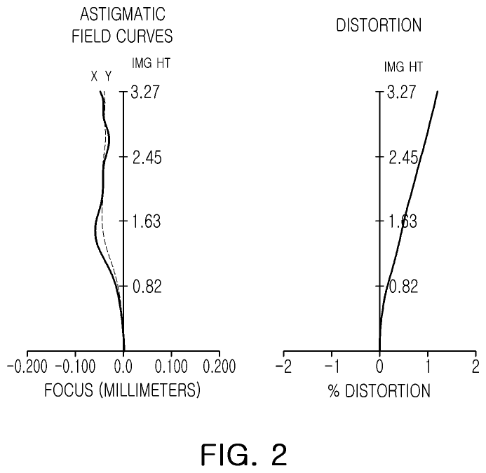

The optical imaging system 100, according to the first embodiment, may be described with reference to FIGS. 1 and 2.

The optical imaging system 100, according to the first embodiment, may include a first lens group LG1 and a second lens group LG2. Also, the optical imaging system 100 may include a reflective member P disposed between the first lens group LG1 and the second lens group LG2.

The first lens group LG1 may include a first lens 110, and the second lens group LG2 may include a second lens 120, a third lens 130, a fourth lens 140, and a fifth lens 150, in order from an object side.

Also, the optical imaging system 100 may further include a filter IF and an image sensor IS.

The optical imaging system 100, according to the first embodiment, may form a focus on an imaging plane IP. The imaging plane IP may refer to the surface on which focus is formed by the optical imaging system 100. As an example, the imaging plane IP may refer to one surface of the image sensor on which light is received.

The reflective member P may be implemented as a prism, or may be provided as a mirror.

Lens characteristics (a radius of curvature, thickness of the lens or distance between lenses, index, Abbe number, effective radius, and focal length) of each lens are listed in Table 1.

TABLE 1

| Surface | | Radius of | Thickness or | | Abbe | Effective | Focal | Surface |
|---|---|---|---|---|---|---|---|---|
| No. | Elements | curvature | distance | Index | number | radius | length | No. |
| S1 | First | 13.617 | 0.850 | | 1.535 | 55.7 | 3.500 | 73.29 |
| | lens | | | | | | | |
| S2 | | 20.412 | 0.750 | | | | 3.381 | |
| S3 | Prism | Infinity | 2.350 | | 1.717 | 29.5 | | |
| S4 | | Infinity | 2.350 | | 1.717 | 29.5 | | |
| S5 | | Infinity | 2.500 | | | | | |
| S6 | Second | 2.881 | 1.431 | | 1.535 | 55.7 | 2.100 | 4.8816 |
| | lens | | | | | | | |
| S7 | | −23.001 | 0.100 | | | | 1.979 | |
| S8 | Third | 7.987 | 0.613 | | 1.614 | 25.9 | 1.797 | −4.6507 |
| | lens | | | | | | | |
| S9 | | 2.043 | 1.871 | | | | 1.412 | |
| S10 | Fourth | −3.167 | 0.520 | | 1.671 | 19.2 | 1.500 | 424.276 |
| | lens | | | | | | | |
| S11 | | −3.339 | 0.164 | | | | 1.580 | |
| S12 | Fifth | 2.947 | 0.800 | | 1.567 | 37.4 | 1.690 | 20.1594 |
| | lens | | | | | | | |
| S13 | | 3.580 | 2.000 | | | | 1.800 | |
| S14 | Filter | Infinity | 0.210 | | 1.517 | 64.2 | 4.000 | |
| S15 | | Infinity | 2.224 | | | | 2.604 | |
| S16 | Imaging | Infinity | | | | | | |
| | plane | | | | | | | |

The total focal length f of the optical imaging system 100, according to the first embodiment, is 10.7023 mm, Fno is 2.250, FOV (field of view of the optical imaging system) is 33.594°, IMG HT is 3.269 mm, SDP is 4.7 mm, and ET5 is 0.750 mm.

The focal length of the second lens group LG2 is 11.405 mm.

In a first embodiment, the first lens 110 may have positive refractive power, an object-side surface of the first lens 110 may be convex, and an image-side surface of the first lens 110 may be concave.

The second lens 120 may have positive refractive power, and an object-side surface and an image-side surface of the second lens 120 may be convex.

The third lens 130 may have negative refractive power, an object-side surface of the third lens 130 may be convex, and an image-side surface of the third lens 130 may be concave.

The fourth lens 140 may have positive refractive power, an object-side surface of the fourth lens 140 may be concave, and an image-side surface of the fourth lens 140 may be convex.

The fifth lens 150 may have positive refractive power, an object-side surface of the fifth lens 150 may be convex, and an image-side surface of the fifth lens 150 may be concave.

Each surface of the first lens 110 to the fifth lens 150 may have an aspherical surface coefficient as in Table 2. For example, an object-side surface and an image-side surface of each of the first lens 110 to the fifth lens 150 may be aspherical surfaces.

TABLE 2

| | S1 | S2 | S6 | S7 | S8 |
|---|---|---|---|---|---|
| Conic constant | −7.3349E−01 | −4.3801E+00 | 1.2050E+00 | 8.4277E+00 | 4.3113E+00 |
| (K) | | | | | |
| 4th order | −3.5142E−05 | −5.2212E−05 | 9.0572E−03 | −3.8168E−03 | −2.0101E−02 |
| coefficient (A) | | | | | |
| 6th order | −2.8347E−06 | −3.7740E−06 | −1.5884E−02 | 8.2529E−03 | −8.7269E−03 |
| coefficient (B) | | | | | |
| 8th order | −1.3353E−07 | −2.6627E−07 | 4.2015E−02 | −2.3918E−02 | 5.8461E−02 |
| coefficient (C) | | | | | |
| 10th order | −1.0214E−08 | −1.7784E−08 | −6.9470E−02 | 6.3761E−02 | −1.4651E−01 |
| coefficient (D) | | | | | |
| 12th order | −1.2093E−09 | −1.3626E−09 | 7.7197E−02 | −1.1232E−01 | 2.5057E−01 |
| coefficient (E) | | | | | |
| 14th order | 0.0000E+00 | 0.0000E+00 | −6.0090E−02 | 1.3112E−01 | −3.0936E−01 |
| coefficient f | | | | | |
| 16th order | 0.0000E+00 | 0.0000E+00 | 3.3572E−02 | −1.0529E−01 | 2.7923E−01 |
| coefficient (G) | | | | | |
| 18th order | 0.0000E+00 | 0.0000E+00 | −1.3630E−02 | 5.9597E−02 | −1.8443E−01 |
| coefficient (H) | | | | | |
| 20th order | 0.0000E+00 | 0.0000E+00 | 4.0266E−03 | −2.4015E−02 | 8.8626E−02 |
| coefficient (J) | | | | | |
| 22nd order | 0.0000E+00 | 0.0000E+00 | −8.5678E−04 | 6.8541E−03 | −3.0550E−02 |
| coefficient (L) | | | | | |
| 24th order | 0.0000E+00 | 0.0000E+00 | 1.2792E−04 | 1−1.3542E−03 | 7.3460E−03 |
| coefficient (M) | | | | | |
| 26th order | 0.0000E+00 | 0.0000E+00 | −1.2721E−05 | 1.7617E−04 | −1.1686E−03 |
| coefficient (N) | | | | | |
| 28th order | 0.0000E+00 | 0.0000E+00 | 7.5680E−07 | −1.3572E−05 | 1.1046E−04 |
| coefficient (O) | | | | | |
| 30th order | 0.0000E+00 | 0.0000E+00 | −2.0381E−08 | 4.6907E−07 | −4.6937E−06 |
| coefficient (P) | | | | | |
| | S9 | S10 | S11 | S12 | S13 |
| Conic constant | 1.0471E−01 | −6.8571E+00 | −1.4174E+00 | −2.8668E+01 | −3.1076E+01 |
| (K) | | | | | |
| 4th order | −6.6564E−03 | 3.0130E−02 | −1.1478E−02 | 3.2004E−02 | 1.8770E−02 |
| coefficient (A) | | | | | |
| 6th order | −1.5875E−01 | 7.4026E−02 | 1.2855E−01 | −6.0939E−02 | −3.6597E−02 |
| coefficient (B) | | | | | |
| 8th order | 9.6369E−01 | −4.1610E−01 | −4.1733E−01 | 1.6895E−02 | −1.0951E−02 |
| coefficient (C) | | | | | |
| 10th order | −3.6181E+00 | 1.1728E+00 | 1.0294E+00 | 1.0702E−01 | 1.0721E−01 |
| coefficient (D) | | | | | |
| 12th order | 9.1155E+00 | −2.1342E+00 | −1.8846E+00 | −2.3820E−01 | −1.8724E−01 |
| coefficient (E) | | | | | |
| 14th order | −1.6025E+01 | 2.6497E+00 | 2.5615E+00 | 2.7440E−01 | 1.9026E−01 |
| coefficient f | | | | | |
| 16th order | 2.0133E+01 | −2.2792E+00 | −2.5884E+00 | −2.0286E−01 | −1.2884E−01 |
| coefficient (G) | | | | | |
| 18th order | −1.8304E+01 | 1.3453E+00 | 1.9387E+00 | 1.0056E−01 | 6.0441E−02 |
| coefficient (H) | | | | | |
| 20th order | 1.2061E+01 | −5.2044E−01 | −1.0672E+00 | −3.2964E−02 | −1.9729E−02 |
| coefficient (J) | | | | | |
| 22nd order | −5.7017E+00 | 1.1379E−01 | 4.2459E−01 | 6.5672E−03 | 4.3867E−03 |
| coefficient (L) | | | | | |
| 24th order | 1.8837E+00 | −4.3136E−03 | −1.1847E−01 | −5.5064E−04 | −6.2807E−04 |
| coefficient (M) | | | | | |
| 26th order | −4.1275E−01 | −4.5721E−03 | 2.1950E−02 | −5.8508E−05 | 5.0670E−05 |
| coefficient (N) | | | | | |
| 28th order | 5.3857E−02 | 1.1360E−03 | −2.4219E−03 | 1.7970E−05 | −1.4492E−06 |
| coefficient (O) | | | | | |
| 30th order | −3.1658E−03 | −9.0226E−05 | 1.2032E−04 | −1.2457E−06 | −3.9018E−08 |
| coefficient (P) | | | | | |

Also, the optical imaging system configured above may have aberration properties, as illustrated in FIG. 2.

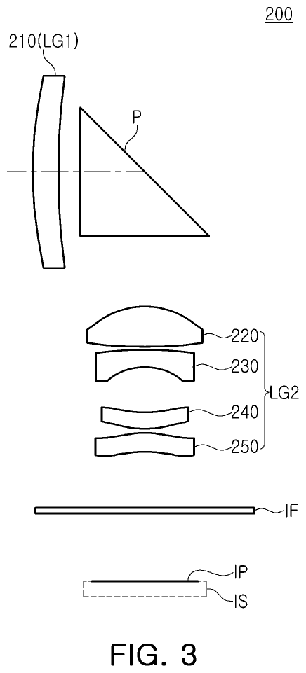

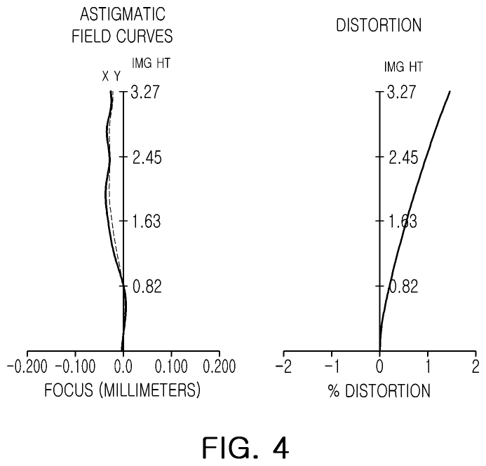

The optical imaging system 200, according to a second embodiment, may be described with reference to FIGS. 3 and 4.

The optical imaging system 200, according to the second embodiment, may include a first lens group LG1 and a second lens group LG2. Also, the optical imaging system 200 may include a reflective member P disposed between the first lens group LG1 and the second lens group LG2.

The first lens group LG1 may include a first lens 210, and the second lens group LG2 may include a second lens 220, a third lens 230, a fourth lens 240, and a fifth lens 250, in order from an object side.

Also, the optical imaging system 200 may further include a filter IF and an image sensor IS.

The optical imaging system 200, according to the second embodiment, may form a focus on an imaging plane IP. The imaging plane IP may refer to the surface on which focus is formed by the optical imaging system. As an example, the imaging plane IP may refer to one surface of the image sensor on which light is received.

The reflective member P may be implemented as a prism, or may be provided as a mirror.

Lens characteristics (radius of curvature, thickness of the lens or distance between lenses, index, Abbe number, effective radius, and focal length) of each lens are listed in Table 3.

TABLE 3

| Surface | | Radius of | Thickness or | | Abbe | Effective | Focal |
|---|---|---|---|---|---|---|---|
| No. | Elements | curvature | distance | Index | number | radius | length |
| S1 | First | 14.723 | 0.950 | 1.535 | 55.7 | 3.500 | 70.2344 |
| | lens | | | | | | |
| S2 | | 23.669 | 0.750 | | | 3.370 | |
| S3 | Prism | Infinity | 2.400 | 1.717 | 29.5 | | |
| S4 | | Infinity | 2.400 | 1.717 | 29.5 | | |
| S5 | | Infinity | 2.500 | | | | |
| S6 | Second | 2.894 | 1.451 | 1.535 | 55.7 | 2.100 | 4.8228 |
| | lens | | | | | | |
| S7 | | −19.592 | 0.100 | | | 1.967 | |
| S8 | Third | 8.404 | 0.627 | 1.614 | 25.9 | 1.791 | −4.5018 |
| | lens | | | | | | |
| S9 | | 2.022 | 1.635 | | | 1.401 | |
| S10 | Fourth | −3.143 | 0.599 | 1.671 | 19.2 | 1.500 | 342.522 |
| | lens | | | | | | |
| S11 | | −3.338 | 0.145 | | | 1.580 | |
| S12 | Fifth | 2.840 | 0.700 | 1.567 | 37.4 | 1.706 | 19.2730 |
| | lens | | | | | | |
| S13 | | 3.494 | 2.000 | | | 1.800 | |
| S14 | Filter | Infinity | 0.210 | 1.517 | 64.2 | 4.000 | |
| S15 | | Infinity | 2.459 | | | 2.461 | |
| S16 | Imaging | Infinity | | | | | |
| | plane | | | | | | |

The total focal length f of the optical imaging system 200, according to the second embodiment, is 10.7028 mm, Fno is 2.238, FOV is 33.495°, IMG HT is 3.269 mm, SDP is 4.8 mm, and ET5 is 0.632 mm.

The focal length of the second lens group LG2 is 11.402 mm.

In a second embodiment, the first lens 210 may have positive refractive power, an object-side surface of the first lens 210 may be convex, and an image-side surface of the first lens 210 may be concave.

The second lens 220 may have positive refractive power, and an object-side surface and an image-side surface of the second lens 220 may be convex.

The third lens 230 may have negative refractive power, an object-side surface of the third lens 230 may be convex, and an image-side surface of the third lens 230 may be concave.

The fourth lens 240 may have positive refractive power, an object-side surface of the fourth lens 240 may be concave, and an image-side surface of the fourth lens 240 may be convex.

The fifth lens 250 may have positive refractive power, an object-side surface of the fifth lens 250 may be convex, and an image-side surface of the fifth lens 250 may be concave.

Each surface of the first lens 210 to the fifth lens 250 may have an aspherical surface coefficient, as in Table 4. For example, an object-side surface and an image-side surface of each of the first lens 210 to the fifth lens 250 may be aspherical surfaces.

TABLE 4

| | S1 | S2 | S6 | S7 | S8 |
|---|---|---|---|---|---|
| Conic constant | −1.4673E+00 | −8.3244E+00 | −1.2193E+00 | 2.9424E+00 | 4.0599E+00 |
| (K) | | | | | |
| 4th order | −6.7359E−05 | −8.9966E−05 | 6.5711E−03 | −1.0117E−02 | −2.5552E−02 |
| coefficient (A) | | | | | |
| 6th order | −3.1856E−06 | −4.3578E−06 | −3.8312E−03 | 1.9092E−02 | 1.9211E−03 |
| coefficient (B) | | | | | |
| 8th order | −1.4206E−07 | −2.8496E−07 | 6.8220E−03 | −2.5069E−02 | 6.4102E−02 |
| coefficient (C) | | | | | |
| 10th order | −7.0775E−09 | −4.7114E−09 | −6.0057E−03 | 3.0564E−02 | −2.1419E−01 |
| coefficient (D) | | | | | |
| 12th order | −8.6456E−10 | −1.3560E−09 | 1.6950E−03 | −3.6732E−02 | 4.0695E−01 |
| coefficient (E) | | | | | |
| 14th order | 0.0000E+00 | 0.0000E+00 | 1.8122E−03 | 3.8422E−02 | −5.1702E−01 |
| coefficient f | | | | | |
| 16th order | 0.0000E+00 | 0.0000E+00 | −2.3798E−03 | −3.0527E−02 | 4.6357E−01 |
| coefficient (G) | | | | | |
| 18th order | 0.0000E+00 | 0.0000E+00 | 1.3887E−03 | 1.7395E−02 | −2.9974E−01 |
| coefficient (H) | | | | | |
| 20th order | 0.0000E+00 | 0.0000E+00 | −5.0371E−04 | −6.9930E−03 | 1.4032E−01 |
| coefficient (J) | | | | | |
| 22nd order | 0.0000E+00 | 0.0000E+00 | 1.2193E−04 | 1.9628E−03 | −4.7081E−02 |
| coefficient (L) | | | | | |
| 24th order | 0.0000E+00 | 0.0000E+00 | −1.9835E−05 | −3.7632E−04 | 1.1024E−02 |
| coefficient (M) | | | | | |
| 26th order | 0.0000E+00 | 0.0000E+00 | 2.0921E−06 | 4.7000E−05 | −1.7087E−03 |
| coefficient (N) | | | | | |
| 28th order | 0.0000E+00 | 0.0000E+00 | −1.2966E−07 | −3.4487E−06 | 1.5740E−04 |
| coefficient (O) | | | | | |
| 30th order | 0.0000E+00 | 0.0000E+00 | 3.5905E−09 | 1.1287E−07 | −6.5201E−06 |
| coefficient (P) | | | | | |
| | S9 | S10 | S11 | S12 | S13 |
| Conic constant | 1.0464E−01 | −6.9419E+00 | −1.3864E+00 | −2.7483E+01 | −3.3130E+01 |
| (K) | | | | | |
| 4th order | −1.3928E−02 | 4.1786E−02 | 5.9503E−03 | 5.2525E−02 | 3.2668E−02 |
| coefficient (A) | | | | | |
| 6th order | −6.1694E−02 | 2.9379E−02 | 8.2241E−02 | −1.0954E−01 | −9.6471E−02 |
| coefficient (B) | | | | | |
| 8th order | 3.5008E−01 | −3.1011E−01 | −3.6265E−01 | 4.3402E−02 | 1.4760E−01 |
| coefficient (C) | | | | | |
| 10th order | −1.1377E+00 | 1.0725E+00 | 1.0711E+00 | 2.5304E−01 | −1.9048E−01 |
| coefficient (D) | | | | | |
| 12th order | 2.3280E+00 | −2.3129E+00 | −2.1666E+00 | −7.1181E−01 | 2.1067E−01 |
| coefficient (E) | | | | | |
| 14th order | −3.0277E+00 | 3.4096E+00 | 3.0931E+00 | 1.0287E+00 | −1.9362E−01 |
| coefficient f | | | | | |
| 16th order | 2.3242E+00 | −3.5571E+00 | −3.1839E+00 | −9.7311E−01 | 1.4179E−01 |
| coefficient (G) | | | | | |
| 18th order | −6.2544E−01 | 2.6651E+00 | 2.3869E+00 | 6.4266E−01 | −7.9835E−02 |
| coefficient (H) | | | | | |
| 20th order | −6.7743E−01 | −1.4364E+00 | −1.3026E+00 | −3.0250E−01 | 3.3620E−02 |
| coefficient (J) | | | | | |
| 22nd order | 8.9618E−01 | 5.5083E−01 | 5.1144E−01 | 1.0131E−01 | −1.0313E−02 |
| coefficient (L) | | | | | |
| 24th order | −5.1000E−01 | −1.4620E−01 | −1.4057E−01 | −2.3618E−02 | 2.2262E−03 |
| coefficient (M) | | | | | |
| 26th order | 1.6468E−01 | 2.5435E−02 | 2.5647E−02 | 3.6464E−03 | −3.1954E−04 |
| coefficient (N) | | | | | |
| 28th order | −2.9320E−02 | −2.5961E−03 | −2.7886E−03 | −3.3528E−04 | 2.7336E−05 |
| coefficient (O) | | | | | |
| 30th order | 2.2475E−03 | 1.1703E−04 | 1.3667E−04 | 1.3904E−05 | −1.0536E−06 |
| coefficient (P) | | | | | |

Also, the optical imaging system configured as above may have aberration properties illustrated in FIG. 4.

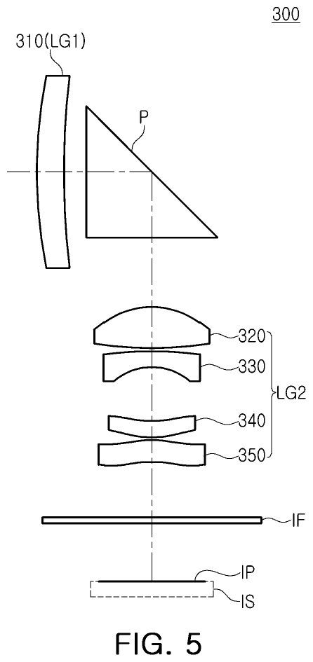

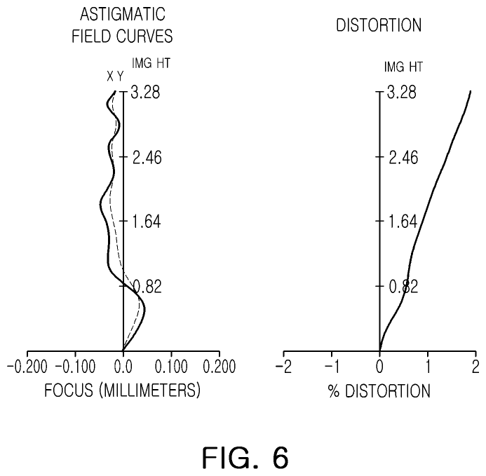

The optical imaging system 300, according to a third embodiment, may be described in reference to FIGS. 5 and 6.

The optical imaging system 300, according to the third embodiment, may include a first lens group LG1 and a second lens group LG2. Also, the optical imaging system 300 may include a reflective member P disposed between the first lens group LG1 and the second lens group LG2.

The first lens group LG1 may include a first lens 310, and the second lens group LG2 may include a second lens 320, a third lens 330, a fourth lens 340 and a fifth lens 350, in order from an object side.

Also, the optical imaging system 300 may further include a filter IF and an image sensor IS.

The optical imaging system 300, according to the third embodiment, may form a focus on an imaging plane IP. The imaging plane IP may refer to the surface on which focus is formed by the optical imaging system 300. As an example, the imaging plane IP may refer to one surface of the image sensor on which light is received.

The reflective member P may be implemented as a prism, or may be provided as a mirror.

Lens characteristics (radius of curvature, thickness of the lens or distance between lenses, index, Abbe number, effective radius, and focal length) of each lens are listed in Table 5.

TABLE 5

| Surface | | Radius of | Thickness or | | Abbe | Effective | Focal |
|---|---|---|---|---|---|---|---|
| No. | Elements | curvature | distance | Index | number | radius | length |
| S1 | First | 17.748 | 1.000 | 1.535 | 55.7 | 3.500 | 76.8593 |
| | lens | | | | | | |
| S2 | | 30.619 | 0.800 | | | 3.354 | |
| S3 | Prism | Infinity | 2.400 | 1.717 | 29.5 | | |
| S4 | | Infinity | 2.400 | 1.717 | 29.5 | | |
| S5 | | Infinity | 2.500 | | | | |
| S6 | Second | 2.889 | 1.501 | 1.535 | 55.7 | 2.100 | 4.6803 |
| | lens | | | | | | |
| S7 | | −15.366 | 0.100 | | | 2.000 | |
| S8 | Third | 8.090 | 0.584 | 1.614 | 25.9 | 1.762 | −4.5321 |
| | lens | | | | | | |
| S9 | | 2.015 | 1.938 | | | 1.384 | |
| S10 | Fourth | −3.099 | 0.578 | 1.671 | 19.2 | 1.500 | −222.795 |
| | lens | | | | | | |
| S11 | | −3.402 | 0.106 | | | 1.580 | |
| S12 | Fifth | 3.088 | 0.800 | 1.614 | 25.9 | 1.750 | 20.7966 |
| | lens | | | | | | |
| S13 | | 3.671 | 2.000 | | | 1.950 | |
| S14 | Filter | Infinity | 0.210 | 1.517 | 64.2 | 4.000 | |
| S15 | | Infinity | 2.095 | | | 2.714 | |
| S16 | Imaging | Infinity | | | | | |
| | plane | | | | | | |

The total focal length f of the optical imaging system 300, according to the third embodiment, is 10.7063 mm, Fno is 2.271, FOV is 33.425°, IMG HT is 3.277 mm, SDP is 4.8 mm, and ET5 is 0.750 mm.

The focal length of the second lens group LG2 is 11.410 mm.

In the third embodiment, the first lens 310 may have positive refractive power, an object-side surface of the first lens 310 may be convex, and an image-side surface of the first lens 310 may be concave.

The second lens 320 may have positive refractive power, and an object-side surface and an image-side surface of the second lens 320 may be convex.

The third lens 330 may have negative refractive power, an object-side surface of the third lens 330 may be convex, and an image-side surface of the third lens 330 may be concave.

The fourth lens 340 may have negative refractive power, an object-side surface of the fourth lens 340 may be concave, and an image-side surface of the fourth lens 340 may be convex.

The fifth lens 350 may have positive refractive power, an object-side surface of the fifth lens 350 may be convex, and an image-side surface of the fifth lens 350 may be concave.

Each surface of the second lens 320 to the fifth lens 350 may have an aspherical surface coefficient, as in Table 6. For example, an object-side surface and an image-side surface of each of the lenses other than the second lens 310 may be aspherical, and as for the first lens 310, an object-side surface and an image-side surface may be spherical.

TABLE 6

| | S1 | S2 | S6 | S7 | S8 |
|---|---|---|---|---|---|
| Conic constant | 0.0000E+00 | 0.0000E+00 | −1.2408E+00 | 4.4853E+00 | 5.5469E+00 |
| (K) | | | | | |
| 4th order | 0.0000E+00 | 0.0000E+00 | 8.2185E−03 | 3.6291E−03 | −1.5180E−02 |
| coefficient (A) | | | | | |
| 6th order | 0.0000E+00 | 0.0000E+00 | −8.2704E−03 | 2.3915E−03 | −9.7951E−03 |
| coefficient (B) | | | | | |
| 8th order | 0.0000E+00 | 0.0000E+00 | 1.5857E−02 | −1.7313E−02 | 6.3541E−02 |
| coefficient (C) | | | | | |
| 10th order | 0.0000E+00 | 0.0000E+00 | −1.7892E−02 | 3.2817E−02 | −2.1190E−01 |
| coefficient (D) | | | | | |
| 12th order | 0.0000E+00 | 0.0000E+00 | 1.1942E−02 | −4.3111E−02 | 4.4047E−01 |
| coefficient (E) | | | | | |
| 14th order | 0.0000E+00 | 0.0000E+00 | −4.2333E−03 | 4.3623E−02 | −6.1279E−01 |
| coefficient f | | | | | |
| 16th order | 0.0000E+00 | 0.0000E+00 | 1.2122E−04 | −3.3096E−02 | 5.9856E−01 |
| coefficient (G) | | | | | |
| 18th order | 0.0000E+00 | 0.0000E+00 | 6.5508E−04 | 1.8247E−02 | −4.1966E−01 |
| coefficient (H) | | | | | |
| 20th order | 0.0000E+00 | 0.0000E+00 | −3.5112E−04 | −7.1882E−03 | 2.1218E−01 |
| coefficient (J) | | | | | |
| 22nd order | 0.0000E+00 | 0.0000E+00 | 9.9679E−05 | 1.9936E−03 | −7.6631E−02 |
| coefficient (L) | | | | | |
| 24th order | 0.0000E+00 | 0.0000E+00 | −1.7619E−05 | −3.7962E−04 | 1.9259E−02 |
| coefficient (M) | | | | | |
| 26th order | 0.0000E+00 | 0.0000E+00 | 1.9489E−06 | 4.7228E−05 | −3.1966E−03 |
| coefficient (N) | | | | | |
| 28th order | 0.0000E+00 | 0.0000E+00 | −1.2426E−07 | −3.4579E−06 | 3.1476E−04 |
| coefficient (O) | | | | | |
| 30th order | 0.0000E+00 | 0.0000E+00 | 3.5005E−09 | 1.1304E−07 | −1.3916E−05 |
| coefficient (P) | | | | | |
| | S9 | S10 | S11 | S12 | S13 |
| Conic constant | 1.1239E−01 | −7.2514E+00 | −1.4345E+00 | −3.6473E+01 | −3.6741E+01 |
| (K) | | | | | |
| 4th order | −1.3590E−02 | 4.6629E−02 | −1.0628E−02 | 2.5531E−02 | 3.5926E−02 |
| coefficient (A) | | | | | |
| 6th order | −1.2066E−01 | −4.0115E−02 | 5.3744E−02 | −2.8544E−02 | −1.2838E−01 |
| coefficient (B) | | | | | |
| 8th order | 8.5759E−01 | −1.5204E−02 | −1.1747E−01 | −2.5835E−01 | 2.5612E−01 |
| coefficient (C) | | | | | |
| 10th order | −3.5345E+00 | 2.5329E−01 | 2.8536E−01 | 1.1203E+00 | −4.0982E−01 |
| coefficient (D) | | | | | |
| 12th order | 9.5548E+00 | −6.9772E−01 | −5.1835E−01 | −2.3895E+00 | 5.1039E−01 |
| coefficient (E) | | | | | |
| 14th order | −1.7841E+01 | 1.1330E+00 | 6.7206E−01 | 3.2679E+00 | −4.8142E−01 |
| coefficient f | | | | | |
| 16th order | 2.3681E+01 | −1.2439E+00 | −6.3263E−01 | −3.0915E+00 | 3.3975E−01 |
| coefficient (G) | | | | | |
| 18th order | −2.2654E+01 | 9.6195E−01 | 4.3751E−01 | 2.0848E+00 | −1.7815E−01 |
| coefficient (H) | | | | | |
| 20th order | 1.5638E+01 | −5.3001E−01 | −2.2232E−01 | −1.0112E+00 | 6.8787E−02 |
| coefficient (J) | | | | | |
| 22nd order | −7.7029E+00 | 2.0672E−01 | 8.1956E−02 | 3.5038E−01 | −1.9239E−02 |
| coefficient (L) | | | | | |
| 24th order | 2.6338E+00 | −5.5681E−02 | −2.1289E−02 | −8.4652E−02 | 3.7837E−03 |
| coefficient (M) | | | | | |
| 26th order | −5.9224E−01 | 9.8316E−03 | 3.6876E−03 | 1.3548E−02 | −4.9544E−04 |
| coefficient (N) | | | | | |
| 28th order | 7.8473E−02 | −1.0212E−03 | −3.8151E−04 | −1.2908E−03 | 3.8739E−05 |
| coefficient (O) | | | | | |
| 30th order | −4.6223E−03 | 4.7110E−05 | 1.7795E−05 | 5.5419E−05 | −1.3674E−06 |
| coefficient (P) | | | | | |

Also, the optical imaging system configured above may have aberration properties, as illustrated in FIG. 6.

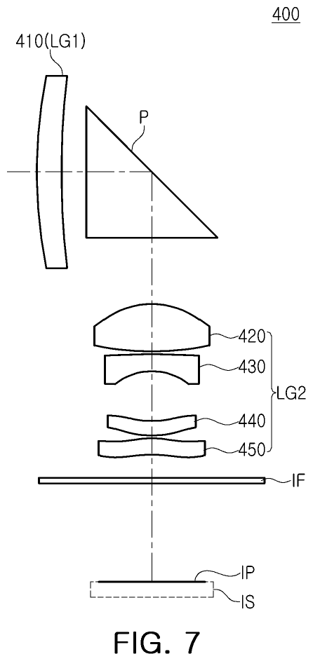

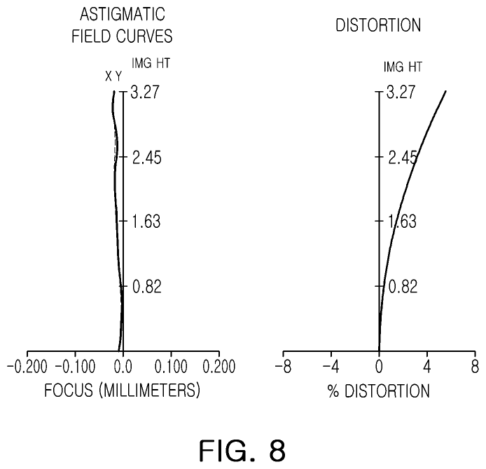

The optical imaging system 400, according to the fourth embodiment, may be described with reference to FIGS. 7 and 8.

The optical imaging system 400, according to the fourth embodiment, may include a first lens group LG1 and a second lens group LG2. Also, the optical imaging system 400 may include a reflective member P disposed between the first lens group LG1 and the second lens group LG2.

The first lens group LG1 may include a first lens 410, and the second lens group LG2 may include a second lens 420, a third lens 430, a fourth lens 440 and a fifth lens 450, in order from an object side.

Also, the optical imaging system 400 may further include a filter IF and an image sensor IS.

The optical imaging system 400, according to the fourth embodiment, may form a focus on an imaging plane IP. The imaging plane IP may refer to the surface on which focus is formed by the optical imaging system 400. As an example, the imaging plane IP may refer to one surface of the image sensor on which light is received.

The reflective member P may be implemented as a prism, or may be provided as a mirror.

Lens characteristics (radius of curvature, thickness of the lens or distance between lenses, index, Abbe number, effective radius, and focal length) of each lens are listed in Table 7.

TABLE 7

| Surface | | Radius of | Thickness or | | Abbe | Effective | Focal |
|---|---|---|---|---|---|---|---|
| No. | Elements | curvature | distance | Index | number | radius | length |
| S1 | First | 17.844 | 0.900 | 1.535 | 55.7 | 3.500 | 80.2661 |
| | lens | | | | | | |
| S2 | | 30.000 | 0.900 | | | 3.370 | |
| S3 | Prism | Infinity | 2.400 | 1.717 | 29.5 | | |
| S4 | | Infinity | 2.400 | 1.717 | 29.5 | | |
| S5 | | Infinity | 2.400 | | | | |
| S6 | Second | 2.948 | 1.714 | 1.535 | 55.7 | 2.100 | 4.6079 |
| | lens | | | | | | |
| S7 | | −11.977 | 0.100 | | | 1.906 | |
| S8 | Third | 11.708 | 0.612 | 1.614 | 25.9 | 1.719 | −4.2078 |
| | lens | | | | | | |
| S9 | | 2.076 | 1.790 | | | 1.362 | |
| S10 | Fourth | −2.788 | 0.536 | 1.671 | 19.2 | 1.500 | 626.293 |
| | lens | | | | | | |
| S11 | | −2.983 | 0.100 | | | 1.618 | |
| S12 | Fifth | 2.998 | 0.589 | 1.614 | 25.9 | 1.810 | 19.0396 |
| | lens | | | | | | |
| S13 | | 3.729 | 0.825 | | | 1.950 | |
| S14 | Filter | Infinity | 0.210 | 1.517 | 64.2 | 4.123 | |
| S15 | | Infinity | 3.554 | | | 4.123 | |
| S16 | Imaging | Infinity | | | | | |
| | plane | | | | | | |

The total focal length f of the optical imaging system 400, according to the fourth embodiment, is 10.7081 mm, Fno is 2.269, FOV is 32.232°, IMG HT is 3.269 mm, SDP is 4.8 mm, and ET5 is 0.518 mm.

The focal length of the second lens group LG2 is 11.311 mm.

In a fourth embodiment, the first lens 410 may have positive refractive power, an object-side surface of the first lens 410 may be convex, and an image-side surface of the first lens 410 may be concave.

The second lens 420 may have positive refractive power, and an object-side surface and an image-side surface of the second lens 420 may be convex.

The third lens 430 may have negative refractive power, an object-side surface of the third lens 430 may be convex, and an image-side surface of the third lens 430 may be concave.

The fourth lens 440 may have positive refractive power, an object-side surface of the fourth lens 440 may be concave, and an image-side surface of the fourth lens 440 may be convex.

The fifth lens 450 may have positive refractive power, an object-side surface of the fifth lens 450 may be convex, and an image-side surface of the fifth lens 450 may be concave.

Each surface of the first lens 410 to the fifth lens 450 may have an aspherical surface coefficient, as in Table 8. For example, an object-side surface and an image-side surface of each of the first lens 410 to the fifth lens 450 may be aspherical surfaces.

TABLE 8

| | S1 | S2 | S6 | S7 | S8 |
|---|---|---|---|---|---|
| Conic constant | 1.2067E+00 | −4.4628E+00 | −1.2252E+00 | 3.6428E+00 | 4.8755E+00 |
| (K) | | | | | |
| 4th order | −3.7995E−05 | −9.0246E−05 | 5.0177E−03 | 1.1109E−02 | −6.0781E−03 |
| coefficient (A) | | | | | |
| 6th order | 3.5689E−06 | 3.9269E−06 | −8.1283E−04 | −4.7096E−03 | −4.9079E−03 |
| coefficient (B) | | | | | |
| 8th order | 5.3865E−07 | 1.0419E−06 | 1.9015E−03 | −2.4790E−02 | −1.5032E−02 |
| coefficient (C) | | | | | |
| 10th order | −4.4633E−08 | −9.7712E−08 | −2.2581E−03 | 6.8462E−02 | 3.8956E−02 |
| coefficient (D) | | | | | |
| 12th order | 8.7107E−10 | 2.7182E−09 | 1.3659E−03 | −9.8537E−02 | −3.9556E−02 |
| coefficient (E) | | | | | |
| 14th order | −7.7886E−12 | −2.8698E−11 | −7.3881E−05 | 9.3446E−02 | 1.2387E−02 |
| coefficient f | | | | | |
| 16th order | 0.0000E+00 | 0.0000E+00 | −5.5359E−04 | −6.2241E−02 | 1.6599E−02 |
| coefficient (G) | | | | | |
| 18th order | 0.0000E+00 | 0.0000E+00 | 4.7239E−04 | 2.9860E−02 | −2.4944E−02 |
| coefficient (H) | | | | | |
| 20th order | 0.0000E+00 | 0.0000E+00 | −2.1116E−04 | −1.0394E−02 | 1.6810E−02 |
| coefficient (J) | | | | | |
| 22nd order | 0.0000E+00 | 0.0000E+00 | 5.9164E−05 | 2.6057E−03 | −6.9313E−03 |
| coefficient (L) | | | | | |
| 24th order | 0.0000E+00 | 0.0000E+00 | −1.0725E−05 | −4.5919E−04 | 1.8425E−03 |
| coefficient (M) | | | | | |
| 26th order | 0.0000E+00 | 0.0000E+00 | 1.2247E−06 | 5.4043E−05 | −3.0932E−04 |
| coefficient (N) | | | | | |
| 28th order | 0.0000E+00 | 0.0000E+00 | −8.0204E−08 | −3.8173E−06 | 2.9930E−05 |
| coefficient (O) | | | | | |
| 30th order | 0.0000E+00 | 0.0000E+00 | 2.2977E−09 | 1.2247E−07 | −1.2747E−06 |
| coefficient (P) | | | | | |
| | S9 | S10 | S11 | S12 | S13 |
| Conic constant | 9.2318E−02 | −7.3077E+00 | −1.7708E+00 | −4.4446E+01 | −4.8342E+01 |
| (K) | | | | | |
| 4th order | −1.5088E−02 | 4.4722E−02 | −3.5777E−02 | 4.2457E−02 | 3.4211E−02 |
| coefficient (A) | | | | | |
| 6th order | −1.9032E−02 | −4.0238E−02 | 2.3088E−01 | −1.1824E−01 | −1.2086E−01 |
| coefficient (B) | | | | | |
| 8th order | 9.3111E−02 | 6.9730E−02 | −6.9652E−01 | 1.3084E−01 | 1.9255E−01 |
| coefficient (C) | | | | | |
| 10th order | −3.6132E−01 | −1.5459E−01 | 1.5962E+00 | −3.2056E−02 | −2.2467E−01 |
| coefficient (D) | | | | | |
| 12th order | 1.0472E+00 | 2.9706E−01 | −2.7260E+00 | −1.4150E−01 | 1.9605E−01 |
| coefficient (E) | | | | | |
| 14th order | −2.2079E+00 | −3.9309E−01 | 3.4587E+00 | 2.6053E−01 | −1.2844E−01 |
| coefficient f | | | | | |
| 16th order | 3.3558E+00 | 3.2312E−01 | −3.2698E+00 | −2.4983E−01 | 6.3103E−02 |
| coefficient (G) | | | | | |
| 18th order | −3.6662E+00 | −1.3286E−01 | 2.3028E+00 | 1.5749E−01 | −2.3079E−02 |
| coefficient (H) | | | | | |
| 20th order | 2.8681E+00 | −1.6231E−02 | −1.1997E+00 | −6.9152E−02 | 6.1860E−03 |
| coefficient (J) | | | | | |
| 22nd order | −1.5886E+00 | 5.3351E−02 | 4.5476E−01 | 2.1378E−02 | −1.1816E−03 |
| coefficient (L) | | | | | |
| 24th order | 6.0740E−01 | −3.1126E−02 | −1.2165E−01 | −4.5758E−03 | 1.5318E−04 |
| coefficient (M) | | | | | |
| 26th order | −1.5236E−01 | 9.3797E−03 | 2.1721E−02 | 6.4644E−04 | −1.2325E−05 |
| coefficient (N) | | | | | |
| 28th order | 2.2550E−02 | −1.5047E−03 | −2.3197E−03 | −5.4263E−05 | 5.0753E−07 |
| coefficient (O) | | | | | |
| 30th order | −1.4920E−03 | 1.0195E−04 | 1.1193E−04 | 2.0502E−06 | −5.6815E−09 |
| coefficient (P) | | | | | |

The optical imaging system configured above may have aberration properties, as illustrated in FIG. 8.

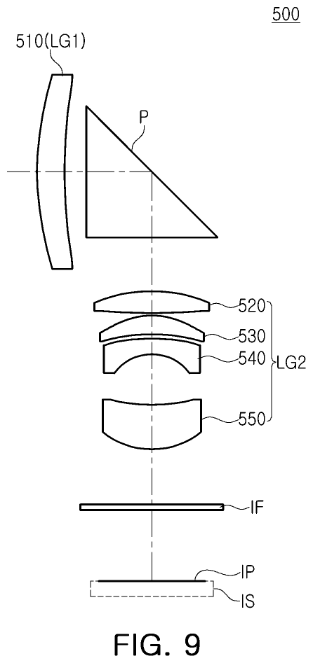

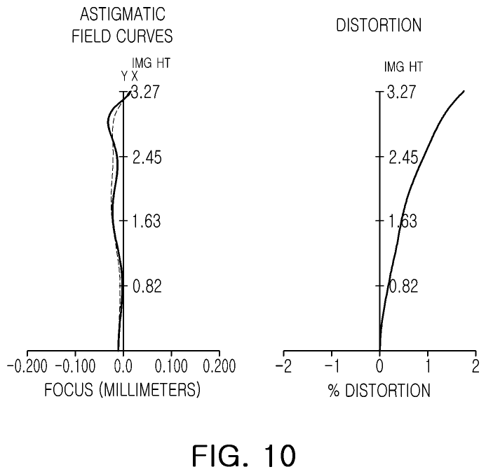

The optical imaging system 500, according to a fifth embodiment, may be described in reference to FIGS. 9 and 10.

The optical imaging system 500, according to the fifth embodiment, may include a first lens group LG1 and a second lens group LG2. Also, the optical imaging system 500 may include a reflective member P disposed between the first lens group LG1 and the second lens group LG2.

The first lens group LG1 may include a first lens 510, and the second lens group LG2 may include a second lens 520, a third lens 530, a fourth lens 540 and a fifth lens 550, in order from an object side.

Also, the optical imaging system 500 may further include a filter IF and an image sensor IS.

The optical imaging system 500, according to the fifth embodiment, may form a focus on an imaging plane IP. The imaging plane IP may refer to the surface on which focus is formed by the optical imaging system 500. As an example, the imaging plane IP may refer to one surface of the image sensor on which light is received.

The reflective member P may be implemented as a prism, or may be provided as a mirror.

Lens characteristics (radius of curvature, thickness of the lens or distance between lenses, index, Abbe number, effective radius, and focal length) of each lens are listed in Table 9.

TABLE 9

| Surface | | Radius of | Thickness or | | Abbe | Effective | Focal |
|---|---|---|---|---|---|---|---|
| No. | Elements | curvature | distance | Index | number | radius | length |
| S1 | First | 9.806 | 1.000 | 1.535 | 55.7 | 3.500 | 49.2333 |
| | lens | | | | | | |
| S2 | | 15.069 | 0.800 | | | 3.358 | |
| S3 | Prism | Infinity | 2.400 | 1.717 | 29.5 | | |
| S4 | | Infinity | 2.400 | 1.717 | 29.5 | | |
| S5 | | Infinity | 1.900 | | | | |
| S6 | Second | 5.623 | 0.780 | 1.535 | 55.7 | 2.100 | 8.3045 |
| | lens | | | | | | |
| S7 | | −20.118 | 0.100 | | | 2.059 | |
| S8 | Third | 2.826 | 0.674 | 1.614 | 25.9 | 1.904 | 7.9397 |
| | lens | | | | | | |
| S9 | | 6.108 | 0.153 | | | 1.811 | |
| S10 | Fourth | 10.377 | 0.561 | 1.671 | 19.2 | 1.765 | −2.9876 |
| | lens | | | | | | |
| S11 | | 1.643 | 1.832 | | | 1.380 | |
| S12 | Fifth | −8.594 | 1.600 | 1.567 | 37.4 | 1.530 | 8.3217 |
| | lens | | | | | | |
| S13 | | −3.252 | 2.000 | | | 1.800 | |
| S14 | Filter | Infinity | 0.210 | 1.517 | 64.2 | 2.522 | |
| S15 | | Infinity | 2.559 | | | 2.560 | |
| S16 | Imaging | Infinity | | | | | |
| | plane | | | | | | |

The total focal length f of the optical imaging system 500, according to the fifth embodiment, is 10.7081 mm, Fno is 2.160, FOV is 33.373°, IMG HT is 3.269 mm, SDP is 4.8 mm, and ET5 is 1.170 mm.

The focal length of the second lens group LG2 is 10.788 mm.

In the fifth embodiment, the first lens 510 may have positive refractive power, an object-side surface of the first lens 510 may be convex, and an image-side surface of the first lens 510 may be concave.

The second lens 520 may have positive refractive power, and an object-side surface and an image-side surface of the second lens 520 may be convex.

The third lens 530 may have positive refractive power, an object-side surface of the third lens 530 may be convex, and an image-side surface of the third lens 530 may be concave.

The fourth lens 540 may have negative refractive power, an object-side surface of the fourth lens 540 may be convex, and an image-side surface of the fourth lens 540 may be concave.

The fifth lens 550 may have positive refractive power, an object-side surface of the fifth lens 550 may be concave, and an image-side surface of the fifth lens 550 may be convex.

Each surface of the first lens 510 to the fifth lens 550 may have an aspherical surface coefficient, as in Table 10. For example, an object-side surface and an image-side surface of each of the first lens 510 to the fifth lens 550 may be aspherical surfaces.

TABLE 10

| | S1 | S2 | S6 | S7 | S8 |
|---|---|---|---|---|---|
| Conic constant | 4.2687E−01 | 9.4217E−01 | −2.0038E−01 | −1.8398E+01 | −1.0864E−01 |
| (K) | | | | | |
| 4th order | −3.9002E−04 | −4.2640E−04 | −6.1150E−04 | 7.2646E−04 | −2.4354E−03 |
| coefficient (A) | | | | | |
| 6th order | −1.9284E−05 | −2.9320E−05 | 8.5374E−06 | 8.0524E−05 | −4.6504E−04 |
| coefficient (B) | | | | | |
| 8th order | −5.9053E−07 | −1.9201E−07 | 1.6831E−05 | 2.4361E−05 | −1.2076E−04 |
| coefficient (C) | | | | | |
| 10th order | −3.7823E−09 | 3.0450E−08 | 5.1159E−06 | 7.1783E−06 | −3.5377E−05 |
| coefficient (D) | | | | | |
| 12th order | 2.1957E−09 | 1.6936E−09 | 7.5113E−07 | 1.1467E−06 | −5.8965E−06 |
| coefficient (E) | | | | | |
| 14th order | 1.2796E−10 | 2.1782E−13 | −4.9156E−09 | −1.7999E−07 | 1.3117E−06 |
| coefficient f | | | | | |
| 16th order | −1.8095E−11 | −1.7984E−11 | 6.6776E−09 | −1.2474E−08 | −4.6796E−08 |
| coefficient (G) | | | | | |
| 18th order | −1.2648E−13 | 2.9734E−13 | 3.4948E−10 | −2.6416E−09 | 4.5255E−09 |
| coefficient (H) | | | | | |
| 20th order | 2.9218E−14 | 9.6684E−15 | −5.3745E−10 | 2.0077E−10 | −5.4290E−09 |
| coefficient (J) | | | | | |
| | S9 | S10 | S11 | S12 | S13 |
| Conic constant | −7.7340E−01 | 1.9352E+01 | −3.5820E−0 | 21.9135E+01 | 1.7531E−01 |
| (K) | | | | | |
| 4th order | −1.0268E−03 | 1.8967E−03 | −8.1609E−03 | −3.0955E−03 | −2.7055E−03 |
| coefficient (A) | | | | | |
| 6th order | −2.7138E−04 | 3.7469E−04 | −1.2570E−03 | 8.6184E−05 | −1.0498E−03 |
| coefficient (B) | | | | | |
| 8th order | −7.2193E−05 | 1.0996E−04 | −4.0367E−04 | −2.2733E−05 | 1.8381E−04 |
| coefficient (C) | | | | | |
| 10th order | −7.9214E−06 | 2.6684E−05 | −2.6421E−05 | 6.5773E−05 | −9.4655E−06 |
| coefficient (D) | | | | | |
| 12th order | 7.3028E−06 | −3.1224E−06 | 4.7201E−05 | 8.7818E−07 | −1.8480E−05 |
| coefficient (E) | | | | | |
| 14th order | 2.0275E−06 | 4.2938E−07 | −1.2044E−04 | 3.6155E−06 | 4.6306E−06 |
| coefficient f | | | | | |
| 16th order | −4.8454E−07 | −3.1907E−07 | 9.8806E−18 | 1.2804E−06 | −4.4408E−07 |
| coefficient (G) | | | | | |
| 18th order | −3.2867E−08 | 8.3651E−08 | 6.4132E−19 | 5.1065E−18 | −4.4955E−10 |
| coefficient (H) | | | | | |
| 20th order | 1.8402E−18 | 2.3508E−18 | 6.3997E−20 | 1.3704E−19 | 3.7557E−09 |
| coefficient (J) | | | | | |

The optical imaging system configured as above may have aberration properties illustrated in FIG. 10.

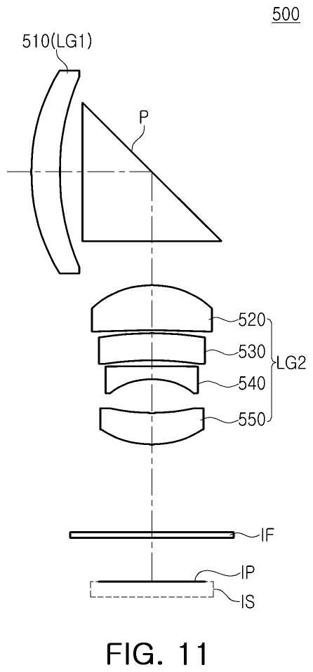

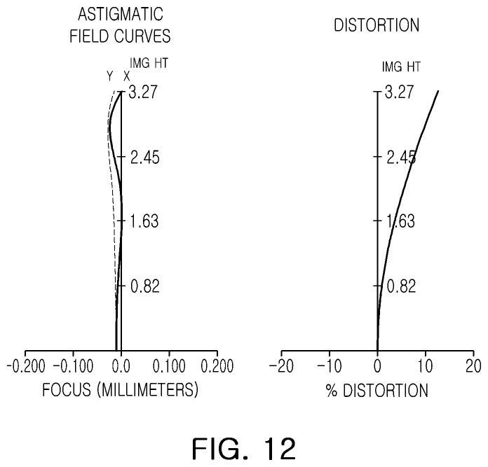

The optical imaging system 600, according to a sixth embodiment, may be described with reference to FIGS. 11 and 12.

The optical imaging system 600, according to the sixth embodiment, may include a first lens group LG1 and a second lens group LG2. Also, the optical imaging system 600 may include a reflective member P disposed between the first lens group LG1 and the second lens group LG2.

The first lens group LG1 may include a first lens 610, and the second lens group LG2 may include a second lens 620, a third lens 630, a fourth lens 640, and a fifth lens 650, in order from an object side.

Also, the optical imaging system 600 may further include a filter IF and an image sensor IS.

The optical imaging system 600, according to the sixth embodiment, may form a focus on an imaging plane IP. The imaging plane IP may refer to the surface on which focus is formed by the optical imaging system 600. As an example, the imaging plane IP may refer to one surface of the image sensor on which light is received.

The reflective member P may be implemented as a prism, or may be provided as a mirror.

Lens characteristics (radius of curvature, thickness of the lens or distance between lenses, index, Abbe number, effective radius, and focal length) of each lens are listed in Table 11.

TABLE 11

| Surface | | Radius of | Thickness or | | Abbe | Effective | Focal |
|---|---|---|---|---|---|---|---|
| No. | Elements | curvature | distance | Index | number | radius | length |
| S1 | First | 7.468 | 1.000 | 1.535 | 55.7 | 3.500 | 64.6845 |
| | lens | | | | | | |
| S2 | | 9.079 | 0.800 | | | 3.271 | |
| S3 | Prism | Infinity | 2.350 | 1.717 | 29.5 | | |
| S4 | | Infinity | 2.350 | 1.717 | 29.5 | | |
| S5 | | Infinity | 2.500 | | | | |
| S6 | Second | 3.097 | 1.557 | 1.535 | 55.7 | 2.100 | 6.0238 |
| | lens | | | | | | |
| S7 | | 65.912 | 0.100 | | | 1.914 | |
| S8 | Third | 12.342 | 0.934 | 1.614 | 25.9 | 1.854 | 84.6266 |
| | lens | | | | | | |
| S9 | | 15.717 | 0.194 | | | 1.628 | |
| S10 | Fourth | 56.569 | 0.456 | 1.661 | 20.4 | 1.606 | −4.0807 |
| | lens | | | | | | |
| S11 | | 2.565 | 1.156 | | | 1.457 | |
| S12 | Fifth | −5.675 | 1.100 | 1.639 | 23.5 | 1.635 | 8.8646 |
| | lens | | | | | | |
| S13 | | −3.050 | 3.000 | | | 1.800 | |
| S14 | Filter | Infinity | 0.210 | 1.517 | 64.2 | 2.802 | |
| S15 | | Infinity | 1.498 | | | 2.840 | |
| S16 | Imaging | Infinity | | | | | |
| | plane | | | | | | |

The total focal length f of the optical imaging system 600, according to the sixth embodiment, is 10.7084 mm, Fno is 2.149, FOV is 30.297°, IMG HT is 3.269 mm, SDP is 4.7 mm, and ET5 is 0.722 mm.

The focal length of the second lens group LG2 is 10.976 mm.

In a sixth embodiment, the first lens 610 may have positive refractive power, an object-side surface of the first lens 610 may be convex, and an image-side surface of the first lens 610 may be concave.

The second lens 620 may have positive refractive power, an object-side surface of the second lens 620 may be convex, and an image-side surface of the second lens 620 may be concave.

The third lens 630 may have positive refractive power, an object-side surface of the third lens 630 may be convex, and an image-side surface of the third lens 630 may be concave.

The fourth lens 640 may have negative refractive power, an object-side surface of the fourth lens 640 may be convex, and an image-side surface of the fourth lens 640 may be concave.

The fifth lens 650 may have positive refractive power, an object-side surface of the fifth lens 650 may be concave, and an image-side surface of the fifth lens 650 may be convex.

Each surface of the first lens 610 to the fifth lens 650 may have an aspherical surface coefficient, as in Table 12. For example, an object-side surface and an image-side surface of each of the first lens 610 to the fifth lens 650 may be aspherical surfaces.

TABLE 12

| | S1 | S2 | S6 | S7 | S8 |
|---|---|---|---|---|---|
| Conic constant | 1.2302E−01 | −3.2309E−01 | 0.0000E+00 | 0.0000E+00 | −3.0107E+00 |
| (K) | | | | | |
| 4th order | 4.3660E−04 | 4.3382E−04 | −1.5734E−03 | −4.0061E−04 | 7.5438E−04 |
| coefficient (A) | | | | | |
| 6th order | 2.0104E−05 | 2.3242E−05 | 7.3894E−05 | 1.5512E−04 | −1.2268E−04 |
| coefficient (B) | | | | | |
| 8th order | 1.6772E−07 | 8.6076E−07 | −6.2268E−06 | 4.2344E−05 | −7.6159E−05 |
| coefficient (C) | | | | | |
| 10th order | −8.1261E−09 | −5.0570E−08 | −1.5927E−06 | −2.4529E−06 | 2.8834E−06 |
| coefficient (D) | | | | | |
| 12th order | −1.3775E−09 | −7.2866E−09 | 1.3157E−07 | −1.3976E−06 | 4.1240E−06 |
| coefficient (E) | | | | | |
| 14th order | −1.5927E−10 | −4.9189E−10 | 1.8828E−07 | 8.5131E−07 | −2.0485E−08 |
| coefficient f | | | | | |
| 16th order | 7.3462E−12 | 3.5619E−11 | 0.0000E+00 | 0.0000E+00 | −5.2181E−09 |
| coefficient (G) | | | | | |
| 18th order | −7.0502E−13 | 1.3500E−12 | 0.0000E+00 | 0.0000E+00 | 3.3276E−10 |
| coefficient (H) | | | | | |
| 20th order | 3.3270E−14 | −8.1025E−14 | 0.0000E+00 | 0.0000E+00 | 3.6468E−20 |
| coefficient (J) | | | | | |
| | S9 | S10 | S11 | S12 | S13 |
| Conic constant | 2.0000E+01 | −2.0000E+01 | −5.4774E−02 | −4.7896E+00 | −1.2126E−01 |
| (K) | | | | | |
| 4th order | 2.1667E−03 | −1.2014E−03 | 9.9266E−03 | 5.4905E−03 | 4.1607E−03 |
| coefficient (A) | | | | | |
| 6th order | 4.1875E−04 | 3.4411E−05 | −4.2262E−04 | 6.5569E−04 | 1.8501E−04 |
| coefficient (B) | | | | | |
| 8th order | 8.2257E−05 | 5.1710E−05 | 7.7974E−05 | 5.0831E−05 | −6.1143E−05 |
| coefficient (C) | | | | | |
| 10th order | 4.5977E−07 | 4.1161E−05 | −1.7356E−05 | 1.2207E−04 | −4.6225E−06 |
| coefficient (D) | | | | | |
| 12th order | 3.4991E−06 | 1.9074E−06 | 3.5481E−05 | −2.5747E−05 | 3.5227E−06 |
| coefficient (E) | | | | | |
| 14th order | 5.6783E−06 | 3.7405E−07 | −1.5605E−05 | 5.0400E−06 | 6.8656E−07 |
| coefficient f | | | | | |
| 16th order | −1.0454E−18 | 7.9919E−18 | 1.3785E−18 | −6.7482E−17 | −6.7744E−09 |
| coefficient (G) | | | | | |
| 18th order | −4.6275E−19 | 3.4967E−19 | −4.8052E−20 | −3.3055E−18 | 1.4910E−08 |
| coefficient (H) | | | | | |
| 20th order | −2.5856E−20 | 2.8049E−21 | −1.1124E−20 | −5.5547E−20 | 6.5625E−18 |
| coefficient (J) | | | | | |

The optical imaging system configured above may have aberration properties, as illustrated in FIG. 12.

TABLE 13

| | Embodiment 1 | Embodiment 2 | Embodiment 3 | Embodiment 4 | Embodiment 5 | Embodiment 6 |
|---|---|---|---|---|---|---|
| SD1/SDP | 1.489 | 1.458 | 1.458 | 1.458 | 1.458 | 1.489 |
| f/SDP | 2.277 | 2.230 | 2.230 | 2.231 | 2.231 | 2.278 |
| IMG HT/BFL | 0.737 | 0.700 | 0.761 | 0.712 | 0.685 | 0.694 |
| \|R10/f\| | 0.334 | 0.326 | 0.343 | 0.348 | 0.304 | 0.285 |
| Lf/IMG HT | 1.208 | 1.254 | 1.282 | 1.285 | 1.285 | 1.270 |
| fG1/f | 6.848 | 6.562 | 7.179 | 7.496 | 4.598 | 6.041 |
| \|(R1 − R2)/ | 0.200 | 0.233 | 0.266 | 0.254 | 0.212 | 0.097 |
| (R1 + R2)\| | | | | | | |
| SD1/BFL | 1.579 | 1.499 | 1.626 | 1.525 | 1.468 | 1.487 |
| CT5/ET5 | 1.066 | 1.107 | 1.067 | 1.136 | 1.368 | 1.524 |
| D1P/DR | 0.319 | 0.313 | 0.333 | 0.375 | 0.333 | 0.340 |
| fG2/f | 1.066 | 1.065 | 1.066 | 1.056 | 1.007 | 1.025 |
| fG1/fG2 | 6.426 | 6.160 | 6.736 | 7.096 | 4.564 | 5.894 |

According to the aforementioned embodiments, the size of the optical imaging system may be reduced, and high-resolution images may be taken.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens group, comprising one or more lenses, having positive refractive power;
a second lens group comprising a plurality of lenses; and
a reflective member, disposed between the first lens group and the second lens group, comprising an incident surface, a reflective surface, and an emitting surface,
wherein 1.3<SD1/SDP<1.7 is satisfied, where SD1 is an effective diameter of an object-side surface of a first lens disposed closest to an object side among the one or more lenses of the first lens group, and SDP is a minor-axis length of the incident surface of the reflective member.

2. The optical imaging system of claim 1, wherein the reflective member and the first lens group are configured to rotate together with respect to two axes perpendicular to each other.

3. The optical imaging system of claim 2, wherein the two axes are perpendicular to an optical axis of the second lens group.

4. The optical imaging system of claim 1, wherein 2.1<f/SDP<2.4 is satisfied, where f is a total focal length of the optical imaging system.

5. The optical imaging system of claim 1, wherein 0.6<IMG HT/BFL<0.8 is satisfied, where IMG HT is half a diagonal length of an imaging plane, and BFL is a distance from an image-side surface of a lens disposed closest to the imaging plane, among the plurality of lenses of the second lens group, to the imaging plane.

6. The optical imaging system of claim 1, wherein 0.2<R10/f|<0.5 is satisfied, where R10 is a radius of curvature of an image-side surface of a lens disposed closest to an imaging plane among the plurality of lenses of the second lens group, and f is a total focal length of the optical imaging system.

7. The optical imaging system of claim 1, wherein 1.0<Lf/IMG HT<1.5 is satisfied, where Lf is a distance from the object-side surface of the first lens to the reflective surface of the reflective member, and IMG HT is half a diagonal length of an imaging plane.

8. The optical imaging system of claim 1, wherein 4.0<fG1/f<8.0 is satisfied, where fG1 is a focal length of the first lens group, and f is a total focal length of the optical imaging system.

9. The optical imaging system of claim 1, wherein |(R1−R2)/(R1+R2)|<0.4 is satisfied, where R1 is a radius of curvature of the object-side surface of the first lens, and R2 is a radius of curvature of an image-side surface of the first lens.

10. The optical imaging system of claim 1, wherein 1.2<SD1/BFL<1.9 is satisfied, where BFL is a distance from an image-side surface of a lens disposed closest to an imaging plane, among the plurality of lenses of the second lens group, to the imaging plane.

11. The optical imaging system of claim 1, wherein 0.9<CT5/ET5<1.8 is satisfied, where CT5 is a thickness on an optical axis of a lens disposed closest to an imaging plane among the plurality of lenses of the second lens group, ET5 is a thickness on an end of an effective diameter of the lens disposed closest to the imaging plane among the plurality of lenses of the second lens group.

12. The optical imaging system of claim 1, wherein an Abbe number of the first lens is greater than an Abbe number of the reflective member.

13. The optical imaging system of claim 1,
wherein the second lens group has positive refractive power, and
wherein a focal length of the second lens group is smaller than a focal length of the first lens group.

14. The optical imaging system of claim 1, wherein 4<fG1/fG2<8 is satisfied, where fG1 is a focal length of the first lens group, and fG2 is a focal length of the second lens group.

15. The optical imaging system of claim 1, wherein a lens disposed closest to the reflective member, among the plurality of lenses of the second lens group, has positive refractive power.

16. The optical imaging system of claim 1, wherein the first lens group comprises the first lens, and the object-side surface of the first lens is convex and an image-side surface of the first lens is concave.
